(19) United States
(12) Patent Application Publication
(10) Pub. No.: US 2006/0067784 A1
(43) Pub. Date: Mar. 30, 2006

(54) Paint applicator devices

(75) Inventors: Craig S. Serio, New Berlin, WI (US); Michael H. Reedy, Chicago, IL (US); Darren W. Stoddart, Fenton, MO (US); Brian S. Potempa, Oak Creek, WI (US); Michael M. Potempa, Oak Creek, WI (US); Joshua Nelson, Milwaukee, WI (US); Ki Bok Song, Des Plaines, IL (US)

Correspondence Address: TAFT, STETTINIUS & HOLLISTER LLP, SUITE 1800, 425 WALNUT STREET, CINCINNATI, OH, 45202-3957, US

(73) Assignee: NEWELL OPERATING COMPANY, Freeport, IL (US)

(21) Appl. No.: 11/191,323

(22) Filed: Jul. 28, 2005

Related U.S. Application Data
(63) Continuation-in-part of application No. 10/769,933, filed on Feb. 2, 2004.

(51) Int. Cl. B43M 11/02

(52) U.S. Cl. 401/219

(57) ABSTRACT

The disclosure generally relates to paint applicators, and more particularly to paint applicators comprising a container having an opening, and a housing assembly removably attachable to the container, the housing assembly comprising a paint application element in fluid communication with a contents of the container.

### CROSS REFERENCE To RELATED APPLICATION

This is a continuation-in-part of U.S. patent application Ser. No. 10/769,933 filed Feb. 2, 2004, the entire respective disclosure of which is hereby incorporated by reference.

### FIELD OF THE DISCLOSURE

The disclosure generally relates to paint applicators, and more particularly to paint applicators comprising a container and a housing assembly removably attachable to the container.

### BACKGROUND OF THE DISCLOSURE

Paint applicators such as paint brushes, paint rollers, and paint pads are well known. Brushes allow for accurate paint application and are readily available in a wide array of sizes. Paint rollers are often used to apply paint to relatively large surfaces, e.g., walls and ceilings. Foam paint pads can be used to apply paint to surfaces having intricate textures. Moreover, foam paint pads often have straight or angular edges so as to enable paint application along a straight trim line or to a corner.

Such conventional paint applicators, however, are not particularly well suited for relatively smaller painting jobs, particularly where a previously painted surface is being “touched-up” with a fresh coat of paint. For example, a user must first transfer paint to a non-integral, secondary unit such as a paint can or a roller tray before loading such conventional paint applicators with paint. The required paint loading can be messy due to dripping, splattering, and the like, and wasteful due to paint adhering to the sides of the paint can, roller tray, and/or paint applicator. Additionally, paint disposed in such non-integral, secondary units can become exposed to atmospheric contaminants such as dust and paint chips, which can ultimately result in inferior finishes.

Moreover, cleaning such conventional paint applicators and the associated loading source can be messy and time-consuming. For example, paint roller covers must be removed from the associated paint roller device by grasping the paint soaked paint roller cover and pulling it off of the paint roller assembly frame. Subsequently, the user's hands must also be thoroughly cleaned. Further, the secondary sources must be refilled with paint each time a user wants to perform a paint job, thereby wasting time and paint each time a paint job (touch-up or larger) is undertaken.

### SUMMARY OF THE DISCLOSURE

Paint applicators in accordance with the disclosure generally comprise a container and a housing assembly for housing a paint application element removably attachable to the container. Paint applicators in accordance with the disclosure generally allow users to remove the paint application elements quickly and without engaging the paint application element, and thereby facilitate cleaning (in general) and discarding of the associated paint application elements. Moreover, the paint applicators in accordance with the disclosure include a self-contained paint supply and thus do not require paint loading from a non-integral, secondary source.

According to one embodiment according to the disclosure, a paint applicator comprises a container having an opening, and a housing assembly removably attachable to the container, the housing assembly comprising a paint application element and a push-pull valve, the paint application element being adjacent to the push-pull valve, and the push-pull valve being in fluid communication with a contents of the container.

According to an additional embodiment according to the disclosure, a paint applicator comprises a container having an opening, and a housing assembly removably attachable to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover.

According to a further embodiment according to the disclosure, a paint applicator comprises a container having an opening and a housing assembly removably attachable to the container, the housing assembly comprising a paint application element and a push-pull valve including an actuation member extending from a portion of the push-pull valve for actuating the push-pull valve between a closed position that precludes fluid flow and an open position that permits fluid flow, the paint application element being adjacent to the push-pull valve, and the push-pull valve being in fluid communication with a contents of the container.

According to another embodiment according to the disclosure, a paint applicator comprises a container having an opening, a housing assembly comprising a cap, a cover, and a paint roller cover in fluid communication with a contents of the container, the housing assembly being removably attachable to the container, and the cover including a depressible button partially received in and projecting from an exterior surface thereof, the depressible button being selectively movable to disengage the cover from the cap.

According to yet another embodiment according to the disclosure, a method of applying paint to a surface comprises engaging a surface with a paint applicator comprising a container having an opening, and a housing assembly removably attachable to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover, and traversing the surface with the paint roller cover.

### BRIEF DESCRIPTION OF THE DRAWINGS

Exemplary aspects and features of paint applicators in accordance with the disclosure are described and explained in greater detail below with the aid of the drawing figures in which:

FIG. 1 is a perspective view illustrating a paint applicator in accordance with the disclosure;

FIG. 2 is an exploded view of the paint applicator shown in FIG. 1;

FIG. 3 is a front perspective view illustrating a housing assembly in accordance with the disclosure;

FIG. 4 is a rear perspective view of the housing assembly shown in FIG. 3;

FIG. 5 is a perspective view illustrating a second example of a paint applicator in accordance with the disclosure;

FIG. 6 is an exploded view of the paint applicator shown in FIG. 5;

FIG. 7 is a front perspective view illustrating a second example of a housing assembly in accordance with the disclosure;

FIG. 8 is a front perspective view illustrating a cap in accordance with the disclosure;

FIG. 9 is a rear perspective view of the cap shown in FIG. 8;

FIG. 10 is a perspective view illustrating the coupling interaction between a cap and a cover in accordance with the disclosure; and,

FIG. 11 is a perspective view of a funnel capable of being coupled to a paint applicator container.

### DETAILED DESCRIPTION OF THE DISCLOSURE

Although the paint applicators in accordance with the disclosure are described herein for use in conjunction with paint, the term “paint” is defined herein as any type of liquid material adapted to be applied to a surface for decoration or protection thereof. Accordingly, “paint” as used herein includes not only paint, but stains, lacquers, varnishes, sealants, adhesives, cleaning solutions (e.g., grout cleaner, and tile cleaner) and the like.

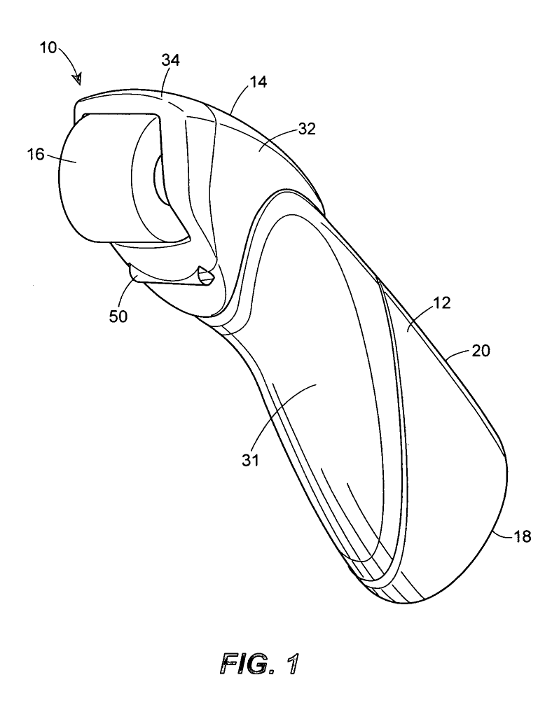

With reference to FIGS. 1-4, a paint applicator in accordance with the disclosure is generally shown as paint applicator 10. The paint applicator 10 generally includes a container 12, a housing assembly 14, and a paint application element 16 (exemplified in FIGS. 1-4 as a paint roller cover 16) housed by the housing assembly 14.

The container 12 includes a bottom surface 18 from which a perimeter side wall 20 upwardly extends. Although the container 12 is shown as having the general shape of a bottle, the container 12 can be of any suitable shape and/or configuration provided that the container 12 is adapted to store a liquid such as paint and has an opening to receive the housing assembly 14, as described below.

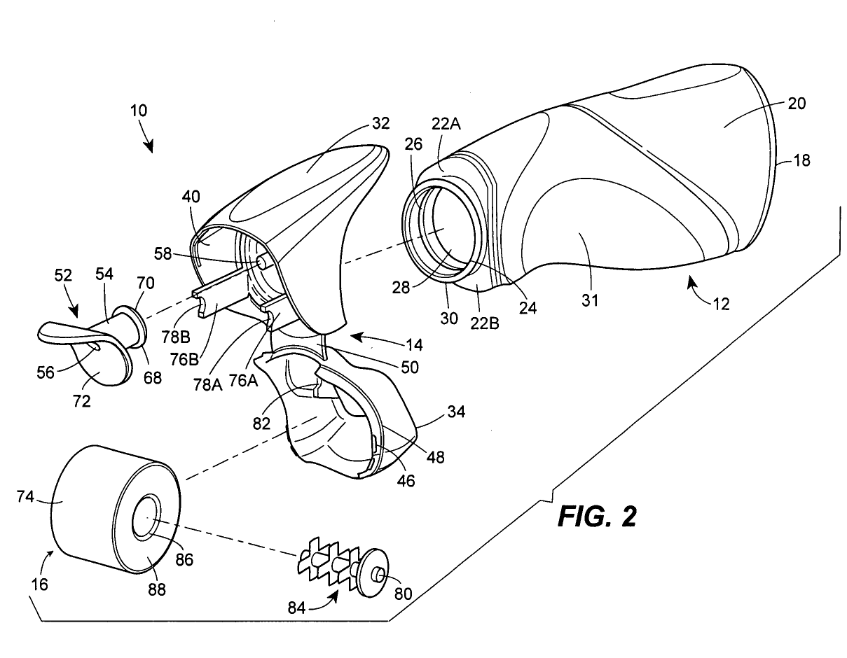

In the embodiment shown in FIGS. 1-4, the perimeter side wall 20 of container 12 generally terminates at shoulders 22A, 22B, which provide a rim 24 extending therefrom (see FIG. 2). The rim 24 generally defines an opening 26 providing access to an interior 28 of the container 12. Containers having openings 26 in different positions (e.g., not at the top of the container) may also be used. A bead 30 can be provided about the circumference of the rim 24. Such a bead 30 can facilitate attachment of the container 12 to the housing assembly 14, as described below.

The container 12 can be configured such that a user can comfortably grasp container 12. For example, the container 12 can be formed such that the dimensions of the perimeter side wall 20 vary upwardly, e.g., at locations between the bottom surface 18 and the shoulders 22A, 22B, in order to provide an ergonomic gripping surface 31 for a user, as shown in FIGS. 1-4. At least a portion (not shown) of the gripping surface 31 can be textured if desired to further augment the user's ability to controllably apply paint to a surface to be painted with the paint applicator 10.

The housing assembly 14 generally houses or contains the paint application element 16 when the paint applicator 10 is in use. Notwithstanding the exemplification of the paint application element 16 as a paint roller cover in FIGS. 1-4, a number of paint application elements can be used in paint applicators 10 including but not limited to a paint pad (not shown) or a bristled applicator (not shown). Additionally, the paint application element 16 may be of any size including but not limited to about one inch wide, about two inches wide, about three inches wide, about four inches wide, about five inches wide, etc., up to and including standard roller cover lengths such as, for example, about seven inches and about twelve inches. Thus, the paint applicator 10 may be used for any size painting job. However, it is generally preferred that the paint application element is less than about two inches wide so as to facilitate its use for small painting jobs, and particularly for touch up painting jobs.

The housing assembly 14 is removably attachable to the container 12 and thus can be removed in order to provide access to the interior 28 of the container 12. In one embodiment, the housing assembly 14 substantially seals the container 12 by a snap-fit interference engagement. Such a snap-fit interference engagement allows the user to quickly remove the housing assembly 14 from the container 12 and fill and/or empty the fluid contents of the container 12.

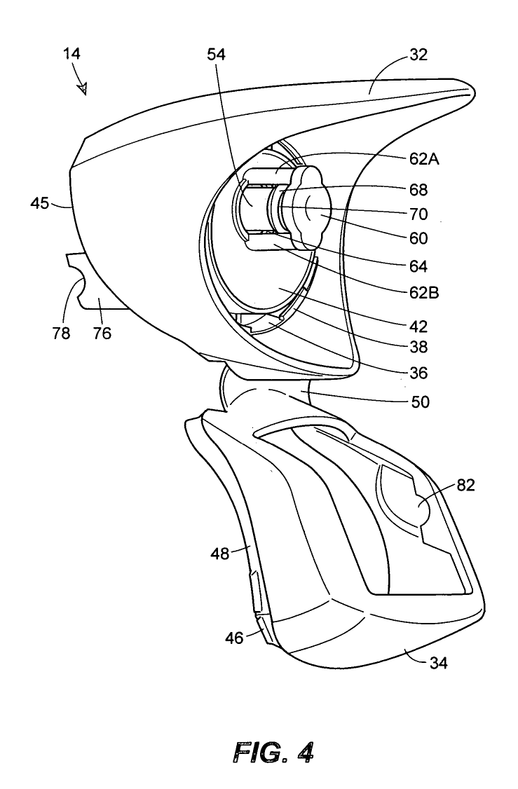

For example, in one embodiment, the housing assembly 14 comprises a cap 32 adapted to substantially seal opening 26 of container 12. The cap 32 can include an annular channel or groove 36 for releasably receiving the rim 24 of the container 12. As shown in FIG. 4, the annular channel 36 can include a plurality of tabs or ribs 38 that are adapted to interact with the bead 30 of the container rim 24 so as to provide a snap-fit interference engagement between the cap 32 and the container 12 which is capable of substantially sealing the cap 32 to the container 12.

Other mechanisms may also be used to attach the cap 32 of the housing assembly 14 to the container 12. For example, threads (not shown) can be formed on the outside surface of the container rim 24 and corresponding grooves (not shown) can be formed on the inside of the housing assembly 14, as is conventionally known. Alternatively, the threads (not shown) can be formed on the inside of the housing assembly 14 and corresponding grooves (not shown) can be formed on the outside of the container rim 24.

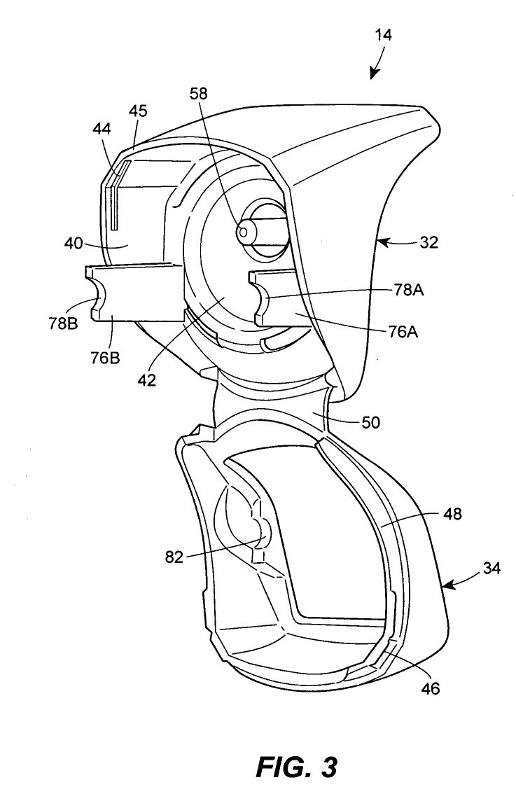

In another embodiment, the housing assembly 14 comprises a cover 34 adapted to engage cap 32. The cap 32 generally includes a perimeter wall 40 extending from a sealing surface 42. In one aspect according to this embodiment, the cap 32 includes a recessed area 44 disposed on a distal edge 45 of the perimeter wall 40 and the cover 34 includes a projection 46 disposed on a lower edge 48 of the cover 34, as best shown in FIG. 3. The projection 46 of the cover 34 is generally adapted to interact with the recessed area 44 of the cap 32 so as to provide a snap-fit interference engagement between the cover 34 and the cap 32. Such a snap-fit interference engagement allows the user to quickly disengage the cover 34 from the cap 32, thereby allowing the user to easily remove the paint application element 16 for cleaning or discarding without touching the paint application element 16. Alternatively, the recessed area 44 can be disposed on the lower edge 48 of the cover cap 34 and the projection 46 can be disposed on the distal edge 45 of the perimeter wall 40 of the cap 32. The cover 34 can also engage the cap 32 via other mechanisms, including but not limited to other interference fits between the cover 34 and the cap 32, as is conventionally known.

As shown by FIGS. 2-4, a living hinge 50 comprising a continuous web of plastic between the cover 34 and the cap 32 can be used to fixedly connect the cover 34 to the cap 32. The living hinge 50 is advantageous for a number of reasons. For example, the user need not store the cover 34 after disengaging the cover 34 from the cap 32 when the living hinge 50 is used. Additionally, as depicted best in FIG. 3, the living hinge 50 generally has an “hour glass” shape wherein the living hinge 50 exterior edge sections have a greater width than an interior section. Such a configuration for the living hinge 50 provides a certain amount of resistance preventing the cover 34 from opening past a certain point. In alternative embodiments, other forms of hinges can be employed. For example, a conventional two leaf hinge and pin design can be used to fixedly connect the cover 34 to the cap 32. Moreover, the cap 32 can be fully separate from the cover 34 and/or include an alternative means for attachment (to the cover 34), such as threads/corresponding grooves or a snap-fit interference engagement (as previously described). Additionally, an aperture (not shown) can be provided in the cap 32 or the cover 34 and a corresponding tab member (not shown) capable of interacting with the aperture can be provided on the cover 34 or the cap 32, respectively, to couple the cap 32 to the cover 34.

The cap 32 also generally includes a valve assembly 52. The valve assembly 52 is in fluid communication with a fluid contents (not shown) contained within the interior 28 of the container 12. In one embodiment according to the disclosure, the valve assembly 52 is a push-pull valve that can be actuated between an open position permitting fluid dispensation from the container 12 and a closed position precluding fluid dispensation from the container 12 by pulling and pushing the valve assembly 52 from and towards the sealing surface 42, respectively. Such valves have been previously used in various containers, including water bottles. One suitable push-pull valve assembly is disclosed in U.S. Pat. No. 4,345,704. Of course, other conventional fluid regulating valves may be used including but not limited to, spool valves, sliding stem valves, rotary valves, and the like.

In the embodiment illustrated in FIGS. 1-4, the valve assembly 52 includes a stem portion 54 having an aperture 56 that receives a post 58 which extends upwardly above sealing surface 42. The post 58 extends from a bridge 60 which is connected to the sealing surface 42 by two members 62A, 62B. The aperture 56 and the post 58 define a pathway 64 for valve 52 actuation and thus fluid flow. The valve assembly 52 is slidably disposed on the post 58. In one embodiment, the aperture 56 of the valve assembly 52 is provided above a central axis (not shown) of the paint roller cover 16 in order to facilitate paint loading through the aperture 56 without mess.

When the valve assembly 52 is actuated to an open position permitting fluid flow from the container 12, an annular flange 68 disposed at a terminal end 70 of the stem portion 54 prevents the detachment of the valve assembly 52 from the cap 32. When the valve assembly 52 is in the closed position, the annular flange 68 prevents fluid from flowing from the container 12 to the associated paint application element 16. FIG. 4 shows the valve assembly 52 in the closed position, i.e., the annular flange 68 is in contact with the bridge 60 so as to prevent fluid flow from the container 12 into the stem portion 54. Conversely, the flange 68 is spaced from the bridge 60 such that a fluid can flow into the stem portion 54 and through the aperture 56 to the associated paint application element 16 when the valve assembly 52 is in the open position.

In one embodiment, the valve assembly 52 includes a face 72 having a contour that is complementary to an outer diameter (or circumference) 74 of the paint roller cover 16. The contoured face 72 may contact the outer diameter 74 of the paint roller cover 16 when the valve assembly 52 is actuated to an open position. Providing a valve assembly with contoured face 72 enables controlled fluid dispensation from container 12 to paint roller cover 16. For example, when the user squeezes the container 12 to force paint through the valve assembly 52 to the paint application element 16, messy paint loading of the paint application element 16 is eliminated. Additionally, when the contoured face 72 is in contact with the outer diameter 74 of the paint application element 16, the paint application element 16 can wipe paint from the contoured face as the paint application element 16 traverses (i.e., is rolled) across a surface to be painted, thereby preventing additional mess.

In one embodiment, the cap 32 is adapted to engage the paint application element 16, e.g., a paint roller cover. For example, in the embodiment illustrated in FIGS. 1-4, posts 76A, 76B extend from the sealing surface 42 above the perimeter wall (or collar) 40 of the cap 32. The posts 76A, 76B include cup-shaped receptacles 78A, 78B for receiving an axle 80 of the paint application element 16. Of course, receptacles having other shapes may also be used to retain the paint application element 16.

The cover 34 can also be similarly adapted to engage the paint application element 16. For example, the cover 34 can include cup-shaped receptacles 82A, 82B for receiving the axle 80 of the paint application element 16. When the cover 34 engages the cap 32, the cup-shaped receptacles 78A, 78B and 82A, 82B form an aperture (not shown) for releasably receiving the axle 80 of the paint application element 16.

In an exemplary embodiment, the axle 80 comprises a removable cage 84 adapted to frictionally engage an inside surface of the paint application element 16. Alternatively, the axle 80 can be integrally formed with the paint application element 16. The paint application element 16 generally comprises a core 86 having an outer circumferential surface configured to be rolled along a surface and to apply (or remove) paint from the adjacent surface. The core 86 is sized so as to be fitted about the axle 80. The core 86 is typically formed from a thermoplastic material, but other conventional materials suitable for core manufacture can also be used.

The paint application element 16 may include a pile fabric 88 secured to the core 86. The pile fabric 88 holds and retains paint until the paint is applied to a surface such as a wall. The core 86 can be covered by various pile fabric 88 materials including but not limited to flocked foam, fabric nap, mohair, natural or synthetic sponge, felt, and the like for the adsorption and application of paint, as is conventionally known.

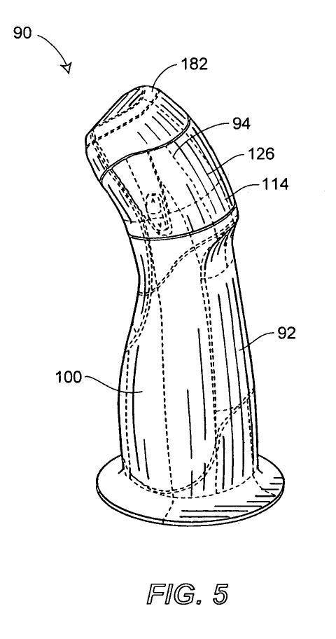

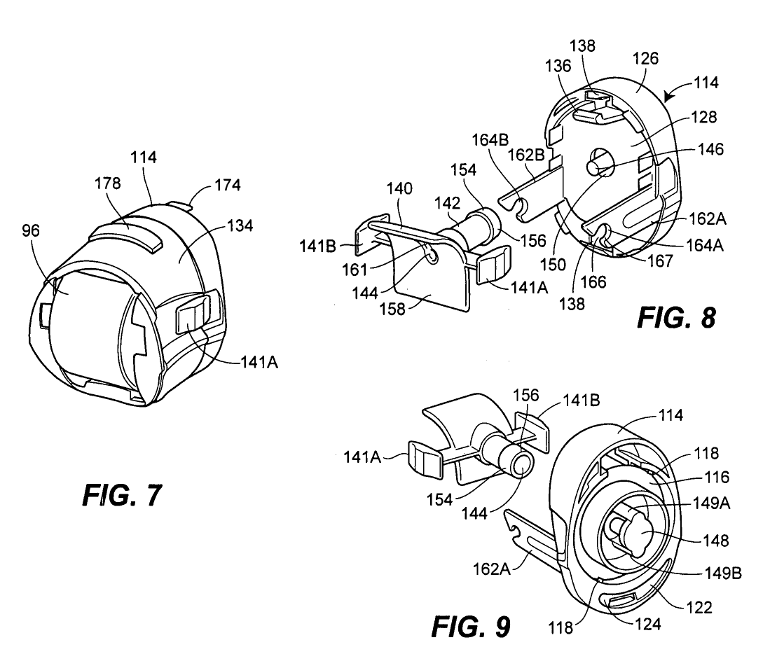

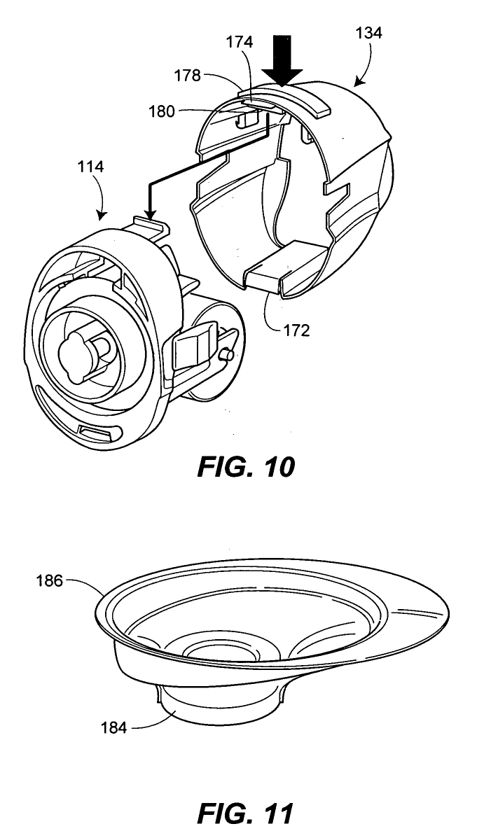

With reference to FIGS. 5-9, a second exemplary paint applicator in accordance with the disclosure is generally shown as paint applicator 90. Paint applicators 90, like paint applicators 10, generally include a container 92, a housing assembly 94, and a paint application element 96 housed by the housing assembly 94.

The container 92 includes a bottom surface 98 from which a perimeter side wall 100 upwardly extends (similar to the side wall 20 of the container 12). Although shown as having the shape of a bottle, the container 92 can be of any suitable shape and/or configuration provided that the container 92 is adapted to store a liquid such as paint and has an opening to receive the housing assembly 94. Additionally, the container 92 can be configured such that a user can comfortably grasp container 92 (for example, as described above with reference to the container 12).

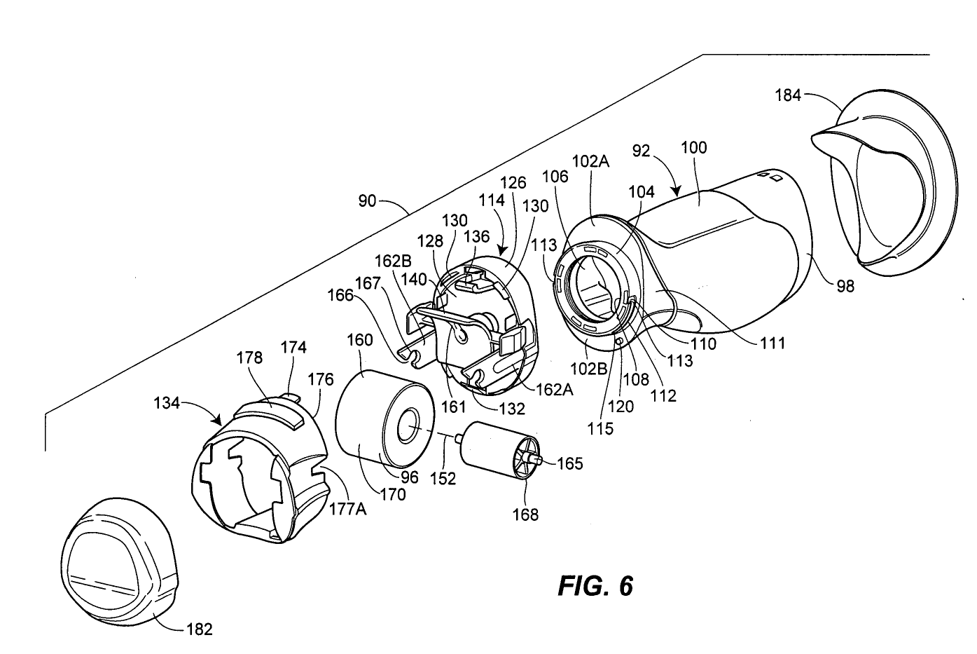

In the embodiment illustrated in FIGS. 5-9, the side wall 100 of the container 92 generally terminates at shoulders 102A, 102B, which provide a rim 104 extending therefrom (see FIG. 6). The rim 104 generally defines an opening 106 providing access to an interior 108 of container 92. The rim 104 further includes one or more slots 110 for accessing one or more sealing channels 112 that facilitate attachment of container 92 to housing assembly 94, as described below. Containers having openings 106 in different positions (e.g., not at the top of the container) may also be used.

In the embodiment illustrated in FIGS. 5-9, a container interface portion 111 which is manufactured from a harder plastic (and can be suitably formed by injection molding) is coupled to the container 92 (which can suitably be formed by blow-molding). The rim 104, the shoulders 102A, 102B, and the slots 110 are generally provided by the container interface portion 111. However, the container 92 may alternatively be blow molded to include the shoulders 102A, 102B, and the slots 110. Furthermore, the container 92 may comprise a single injection molded part including the aforementioned features.

The housing assembly 94 generally houses or contains the paint application element 96 in a manner that is generally similar to the way in which the housing assembly 14 houses the paint application element 16. A number of paint application elements 96 can be used in the paint applicator 90 including but not limited to a paint roller cover 96 (as shown), a paint pad (not shown), and a bristled applicator (not shown). Furthermore, the paint application element 96 may be of any size including but not limited to about one inch long, about two inches long, about three inches long, about four inches long, about five inches long, etc., up to and including standard roller cover lengths, for example about seven inches or about twelve inches. Thus, the paint applicator 90 may be used for any size painting job. However, it is generally preferred that the paint roller cover is less than about two inches long so as to facilitate its use for small painting jobs, and particularly for touch up painting jobs.

The housing assembly 94 is removably attachable to the container 92, and thus can be removed to provide access to interior 108 of the container 92. In the embodiment illustrated in FIGS. 5-9, the housing assembly 94 substantially seals the container 92 by an easy twist and turn interference engagement, which is described in further detail below. Such an engagement allows the user to quickly remove the housing assembly 94 from the container 92, and then fill or empty the fluid contents of the container 92 as desired.

The housing assembly 94 generally comprises a cap 114 adapted to substantially seal opening 106 of container 92. The cap 114 can include an annular channel or groove 116 for releasably receiving the rim 104 of the container 92. As best shown in FIG. 9, the annular channel 116 of the cap 114 can include one or more tabs, posts, or ribs 118 that are adapted to interact with the slots 110 and the channels 112 of the rim 104 so as to substantially seal cap 32 to container 12.

To seal the cap 114 to the container 92, the tabs 118 can be aligned with the slots 110 and then guided into a receiving area 113 of the sealing channels 112. Alignment indicia (not shown) on an outside surface of the housing assembly 94 and on an outside surface the container 92 that generally correspond to the location of the tabs 118 and the receiving area 113 of the sealing channels 112, respectively, can be used to facilitate coupling of the cap 114 to the container 92. The cap 114 can then be substantially sealed to the container 92 by turning the cap approximately 90 degrees in a first direction (e.g., clockwise) such that the tabs 118 are remote from the slots 110 and positioned in a storage area 115 of the sealing channels 112. The cap 114 can be removed by turning the cap 114 approximately 90 degrees in the opposite direction and withdrawing the tabs 118 from the slots 110. Alternatively, the annular channel 116 of the cap 114 can include the slots 110 and the sealing channels 112 and the rim can provide the tabs 118. Of course, other mechanisms including but not limited to threaded engagements and snap-fit interference engagements may also be used to attach the cap 114 of the housing assembly 94 to the container 92.

A locking interaction between the cap 114 and the container 92 can be used to provide a sensory indication that the cap 114 has been coupled to the cap 114 such that the cap 114 substantially seals the container 92. The locking interaction can be generated by rotational coupling of a projecting member 120 disposed on one of the shoulders 102A, 102B and a corresponding channel 122 for receiving the projecting member 120 that is usually disposed proximate the annular channel 116 of the cap 114. The channel 122 can include a stop position 124 capable of retaining the projecting member 120 (within the stop position 124) until an opposing turning force having sufficient torque is applied to the cap 114. The stop position 124 can be a depressed or lowered area (relative to its surrounding surfaces) capable of receiving the projecting member, and thus providing a sensory indication that the cap 114 is substantially sealed to the container 92. Of course, other constructions including but not limited to interfering ribs (disposed on both components) can be used to similar effect.

The cap 114 generally comprises a collar 126 extending from and/or generally about a sealing surface 128. The cap 114 can further include one or more generally vertical ribs 130 and/or one or more hook shaped members 132 for facilitating and securing the positioning of a cover 134 relative to the cap 114, as will be described in further detail below. The cap 114 can also include a resilient member 136 projecting from the cap sealing surface 130. The aforementioned projecting structures 130, 132, and 136 are useful in that they interacts with interior surfaces of or otherwise provided by the cover 134, thereby helping to stabilize the two components when they are coupled to one another and/or causing one component to become disengaged from the other, as described in further detail below. The cap 114 may also include one or more recessed areas or apertures 138, the functions of which are also described in further detail below.

The cap 114 also generally includes a valve assembly 140. The valve assembly 140 is in fluid communication with fluid contents (not shown) contained within the interior 108 of container 92. In one embodiment, the valve assembly 140 is a push-pull valve that can be actuated between an open position permitting fluid dispensation from container 92 and a closed position precluding fluid dispensation from container 92 by pulling and pushing the valve assembly 140 from and towards the sealing surface 128, respectively. Of course, other conventional fluid regulating valves may be used including but not limited to, spool valves, sliding stem valves, rotary valves, and the like.

One or more push pull tabs 141A, 141B projecting from a stem portion 142 of the valve assembly 140 and beyond the collar 126 can be used to facilitate opening and closing of the valve assembly 140. The stem portion 142 generally includes an aperture 144 that can receive a post 146 which extends upwardly above the sealing surface 128 of the cap 114. The valve assembly 140 is slidably disposed on the post 146. The post 146 extends from a bridge 148, which in the illustrated embodiment is connected to the sealing surface 128 by two members 149A, 149B. The aperture 144 and the post 146 define a pathway 150 for actuation of the valve assembly 140 (and thus fluid flow). In one embodiment, the aperture 144 of valve assembly 140 is provided above paint application element axis 152 of paint application element 96 in order to facilitate paint loading of paint application element 96 without mess.

When the valve assembly 140 is actuated to an open position permitting fluid flow from the container 92, an annular flange 154 disposed at a terminal end 156 of the stem portion 142 prevents the detachment of the valve assembly 142 from the cap 114. The flange 154 is spaced from the bridge 148 such that a fluid can flow into the stem portion 142 and through the aperture 144 when the valve assembly 140 is in the open position. Conversely, the annular flange 154 is in contact with the bridge 148 and thereby prevents fluid from flowing from container 92 to the associated paint application element 96 when the valve assembly 140 is in the closed position.

In one embodiment, the valve assembly 140 includes a face 158 having a contour that is complementary to an outer diameter or circumference 160 of the paint application element 96. The contoured face 158 may contact the outer diameter 160 of paint roller cover 16 when the valve assembly 140 is actuated to an open position. Providing the valve assembly 140 with the contoured face 158 enables controlled fluid dispensation from container 92 to the paint application element 96. For example, when the user tips and/or squeezes container 92 to force paint through the valve assembly 140 to the paint application element 96, messy paint loading of the paint application element 96 is practically eliminated. Additionally, when the contoured face 158 is in contact with the outer diameter 160 of the paint application element 96, the paint application element 96 can wipe paint (or other liquid material) from the contoured face 158 as the paint application element 96 traverses (i.e., is rolled) across a surface to be painted (or otherwise decorated or cleaned), thereby preventing additional mess. Furthermore, the contoured face 158 can include a groove 161 extending upwardly from the aperture 144 in order to facilitate paint loading of the paint application element 96 as the paint application element 96 traverses across a surface to be painted.

The cap 114 further typically includes posts 162A, 162B extending from the sealing surface 128 and above the collar 126 of the cap 114. The posts 162A, 162B generally include receptacles 164A, 164B for receiving a portion (shown as axle 165) of the paint application element 96 in order to engage and retain the paint application element 96 (e.g., shown as the paint roller cover 96). The receptacles 164A, 164B can include entrances or slots 166 having a width slightly less than the diameter of the axel 165 in order to provide a snap-fit between the posts 162A, 162B and the axel 165. The receptacles 164A, 164B can further include substantially circular portions 167 having a width slightly greater than the diameter of the axel 165 so as to accommodate rotation thereof. Of course, the receptacles 164A, 164B can be configured differently than shown as long as they retain or couple the paint application element 96 to the cap 114.

In an exemplary embodiment, the axle 165 is coupled to a removable cage 168 which is adapted to frictionally engage an inside surface (not shown) of the paint application element 96. Alternatively, the axle 165 and the cage 168 can be integrally formed with the paint application element 96. The paint application element 96 generally comprises a core 169 which is sized so as to be fitted about the axle 165. The core 169 is typically formed from a thermoplastic material, but other conventional materials suitable for core manufacture can also be used. The paint application element 96 may include a pile fabric 170 secured to the core 169. The pile fabric 170 holds and retains paint until the paint is applied to a surface such as a wall. Suitable pile fabrics 170 for the adsorption and application of paint include but are not limited to flocked foam, fabric nap, mohair, natural or synthetic sponge, felt, and the like.

The cover 134 is generally adapted to engage the cap 114. For example, the cover 134 can include a hook-shaped member 172 for engaging the hook shaped member 132 when the cover 134 is coupled to the cap 114. The cover 134 can also include one or more ribs 174 projecting from a bottom surface 176 of the cover 134 for insertion into corresponding recessed areas or apertures 138 of the cap 114. The cap 114 also typically includes one or more channels 177A, 177B for accommodating movement of the push pull tabs 141A, 141B upon actuation of the valve assembly 140. The cover 134 can further include a depressible button 178, which facilitates removal of the cover 134. The button 178 can include an extension arm 180, which generally extends from the button interior surface (not shown) and past an interior surface (not shown) of the cover 134.

In order to couple the cover 134 to the cap 114, the hook shaped member 172 can be positioned within the hook shaped member 132, and the cover 134 rotated into engagement with the cap 114. When the cover 134 is coupled to the cap 114, a portion of the resilient member 136 is proximate to the extension arm 180. Thus, depressing the button 178 can force the extension arm 180 into contacting engagement with the resilient member 136, thereby disrupting the coupling of the cover 134 to the cap 114 and permitting a user to easily remove the cover 134 from the cap 114.

The paint applicator 90 can also further include a paint application element cover 182, which helps to keep the paint application element 96 clean between use. The paint applicator can also include a stand 184 capable of receiving a bottom portion of the container 92, which helps to stabilize the paint applicator 90. Furthermore, the paint applicator 90 can include a funnel 186 so as to permit easy filling of the paint applicator 90 with paint. The funnel 186 can generally be coupled to the container 92 by insertion of an annular flange 188 into the opening 106 of the container 92 such that an annular 190 channel of the funnel 186 receives the rim 104 of the paint container 92.

The disclosure also provides methods of using paint applicators 10, 90. In the disclosed methods, a user engages a surface to be painted with a paint applicator comprising a container having an opening, and a housing assembly removably attachable to the container, the housing assembly comprising a paint roller cover and a valve, the paint roller cover being adjacent to the valve, and the valve being in fluid communication with a contents of the container, and traversing the surface with the paint roller cover. The methods may further include opening the valve to facilitate paint application. The methods may also include positioning the valve in contact with an outer diameter of the paint roller cover. Additionally, the valve can be closed to store the paint contained in container for an extended period of time, without clean-up of the paint applicator. Accordingly, the paint applicators in accordance with the disclosure do not necessitate continuous reloading of a secondary source each time a paint job is initiated.

Containers, caps, and covers for paint applicators according to the disclosure can be manufactured through a variety of methods including, without limitation, injection molding, injection stretch blow molding, thermoforming, extrusion blow molding, injection blow molding, insert molding, co-injection molding, rotational molding, and other methods known in the art. Injection blow molding is the preferred method for manufacturing of containers in accordance with the disclosure. Injection molding is the preferred method for manufacturing caps and covers in accordance with the disclosure.

The containers in accordance with the disclosure are generally flexible enough to allow a user to squeeze the fluid contents contained therein and thereby dispense the fluid contents. A variety of thermoplastic resins can be used to manufacture containers and caps in accordance with the disclosure, including polyethylenes (e.g., high density polyethylene or linear low density polyethylene), polypropylenes (including structural foam comprising polypropylene), polyethylene terephthalates, polyvinyl chlorides, polycarbonates, etc. High density polyethylene and polyethylene terephthalate are preferred materials for cap and container construction, respectively.

Additionally, various thermoplastic elastomers, such as Santoprene® products (Advanced Elastomer Systems, L.P., Akron, Ohio), can be used to provide rubbery gripping surfaces on the exterior of containers in accordance with the disclosure.

Although the foregoing text sets forth a detailed description of numerous different embodiments of paint applicators comprising a container and a housing assembly removably attachable to the container, it should be understood that the detailed description is to be construed as exemplary only and does not describe every possible embodiment of such paint applicators.

What is claimed is:

1. A paint applicator, comprising:
a container having an opening; and,
a housing assembly removably attachable to the container, the housing assembly comprising a paint application element and a push-pull valve including an actuation member extending from a portion of the push-pull valve for actuating the push-pull valve between a closed position that precludes fluid flow from the container to the paint application element and an open position that permits fluid flow from the container to the paint application element, the paint application element being adjacent to the push-pull valve, and the push-pull valve being in fluid communication with a contents of the container.

2. The paint applicator according to claim 1, wherein the actuation member comprises a tab that extends beyond an exterior surface of the housing assembly and the housing assembly includes one or more channels for accommodating movement of the tab.

3. The paint applicator according to claim 1, wherein the housing assembly substantially seals the container by a twist and turn interference engagement.

4. The paint applicator according to claim 3, wherein the container provides a rim including one or more slots for accessing one or more sealing channels, and the cap comprises an annular channel for receiving the rim, the annular channel including one or more tabs adapted to be aligned and inserted into the slots and guided within the sealing channels to substantially seal the housing assembly to the container.

5. The paint applicator according to claim 4, wherein an outside surface of the housing assembly includes alignment indicia corresponding to the location of the tabs.

6. The paint applicator according to claim 4, wherein an outside surface of the container includes alignment indicia corresponding to the location of the slots.

7. The paint applicator according to claim 3, wherein the container provides a rim, the cap comprises an annular channel for receiving the rim and includes one or more slots for accessing one or more sealing channels proximate to the annular channel, and the rim includes one or more tabs adapted to be aligned and inserted into the slots and guided within the sealing channels to substantially seal the housing assembly to the container.

8. The paint applicator according to claim 1, wherein the paint application element is a paint pad.

9. The paint applicator according to claim 1, wherein the paint application element is a paint roller cover.

10. The paint applicator according to claim 9, wherein the push-pull valve comprises a face having a contour that is complementary to an outer diameter of the paint roller cover.

11. The paint applicator according to claim 9, wherein the face is in contact with an outer diameter of the paint roller cover when the valve is in the open position.

12. The paint applicator according to claim 1, wherein an aperture of the push-pull valve is positioned above a centerline of the paint application element.

13. The paint applicator according to claim 1, further comprising a stand capable of receiving the container.

14. The paint applicator according to claim 1, further comprising a funnel capable of being coupled to the opening of the container.

15. A paint applicator, comprising:
a container having an opening;
a housing assembly comprising a cap, a cover, and a paint roller cover in fluid communication with a contents of the container, the housing assembly being removably attachable to the container, and the cover including a depressible button partially received in and projecting from an exterior surface thereof,
the depressible button being selectively movable to disengage the cover from the cap.

16. The paint applicator of claim 15, wherein the housing assembly substantially seals the container by a twist and turn interference engagement.

17. The paint applicator according to claim 16, wherein the container provides a rim including one or more slots for accessing one or more sealing channels, and the cap comprises an annular channel for receiving the rim, the annular channel including one or more tabs adapted to be aligned and inserted into the slots and guided within the sealing channels to substantially seal the housing assembly to the container.

18. The paint applicator according to claim 16, wherein the container provides a rim, the cap comprises an annular channel for receiving the rim and includes one or more slots for accessing one or more sealing channels proximate to the annular channel, and the rim includes one or more tabs adapted to be aligned and inserted into the slots and guided within the sealing channels to substantially seal the housing assembly to the container.

19. The paint applicator according to claim 15, further comprising a stand capable of receiving the container.

20. The paint applicator according to claim 15, further comprising a funnel capable of being coupled to the opening of the container.
